(19) United States
(12) Patent Application Publication
(10) Pub. No.: US 2010/0236421 A1
(43) Pub. Date: Sep. 23, 2010

(54) Fuel saving food cooker and water heater arrangement

(76) Inventor: Pei-De Li, Corona, NY (US)

Correspondence Address: DAVID AND RAYMOND PATENT FIRM, 108 N. YNEZ AVE., SUITE 128, MONTEREY PARK, CA, 91754, US

(21) Appl. No.: 12/308,869

(22) PCT Filed: Jan. 4, 2008
(86) PCT No.: PCT/CN2008/000035

§ 371 Date: Dec. 24, 2008

(51) Int. Cl. A47J 36/00; F24H 1/00

(52) U.S. Cl. 99/357; 122/13.01

(57) ABSTRACT

A fuel saving food cooker and water heater arrangement includes an inner tank body and an outer tank body to define a water chamber between the inner and outer tank bodies, a heat chamber within the inner tank body, a bottom heat inlet communicating with the heat chamber for operatively connecting to a steam outlet of a food cooking apparatus, and an upper heat outlet communicating with the heat chamber, wherein an excessive heat from the food cooking apparatus is guided to pass to the heat chamber through the heat inlet to heat up the water within the water chamber.

### BACKGROUND OF THE PRESENT INVENTION

1. Field of Invention

This present invention relates to a water heater, and more particularly to a water heater which is capable of heating up an amount of water by an excessive heat from a food cooking apparatus, such as an oil fryer, such that the water heater of the present invention is an environmental-friendly and an energy saving device.

2. Description of Related Arts

Many people like to eat fired foods because of its tastes and favorites. Therefore, more and more food companies and restaurant provide fired food on the market. In order to achieve the fired food, those companies and restaurant need to use oil cooker or deep fryer to fry a huge amount of food. When frying the food, the oil cooker usually generates huge amount of heat and steam. And then the steam is usually discharged by the exhaust. Once the temperature of steam is too high, the exhaust channel will be overheated and broken very easily. As a result, the exhaust channel is needed to maintained, repaired, or replaced frequency. In addition, the steam is guided to exhaust directly to the environment. Therefore, the steam not only causes air pollution, but also is a waste of thermal.

### SUMMARY OF THE PRESENT INVENTION

The major object of the present invention is to provide a fuel saving cooker and water heater arrangement, which has a simple structure and design. It fully utilizes the heat generated by an oil cooker for heating up the water in the water tank so as to save energy, reduce exhaust, and protect the environment. Furthermore, the water heater can protect the exhaust channel of the oil cooker from being overheated or burnt by the steam.

Accordingly, in order to accomplish the above object, the present invention provides a fuel saving cooker and water heater arrangement which comprises an inner tank body and an outer tank body, wherein the water tank has a water chamber provided between the inner and outer tank bodies, a heat chamber within the inner tank body, a bottom heat inlet communicating with the heat chamber for operatively connecting to an steam outlet of a food cooking apparatus, and an upper heat outlet communicating with the heat chamber. The excessive heat from the food cooking apparatus is guided to pass to the heat chamber through the heat inlet to heat up water within the water chamber.

The steam at a relatively high temperature produced by the oil cooker is guided to flow from food cooking apparatus to the heat chamber through the heat inlet. After the heat exchange between the water in the water tank and the steam at the heat chamber, the temperature of the steam will be dramatically dropped and the steam will then be discharged to the environment through upper heat outlet. The present invention utilizes the excessive heat from the oil cooker to heat the water in the water tank to minimize the use of other water heating apparatus so as to save the energy to heat the water and to decrease the temperature of the steam before the steam is discharged to the environment. Therefore, the water heater of the present invention is an environmental-friendly and an energy saving device. In addition, the present invention can protect the exhaust channel of the oil cooker from being overheated or burnt by the steam since the steam is cooled down after the heat exchange within the heat chamber.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a fuel saving cooker and water heater arrangement of a preferred embodiment of the present invention.

FIG. 2 is a side sectional view of the fuel saving cooker and water heater arrangement according to the above preferred embodiment of the present invention.

FIG. 3 is a top sectional view of the fuel saving cooker and water heater arrangement according to the above preferred embodiment of the present invention.

FIG. 4 is a sectional view of the fuel saving cooker and water heater arrangement according to the above preferred embodiment of the present invention, illustrating the reinforcing ribs of the present invention.

### DETAILED DESCRIPTION OF THE PREFERRED EMBODIMENT

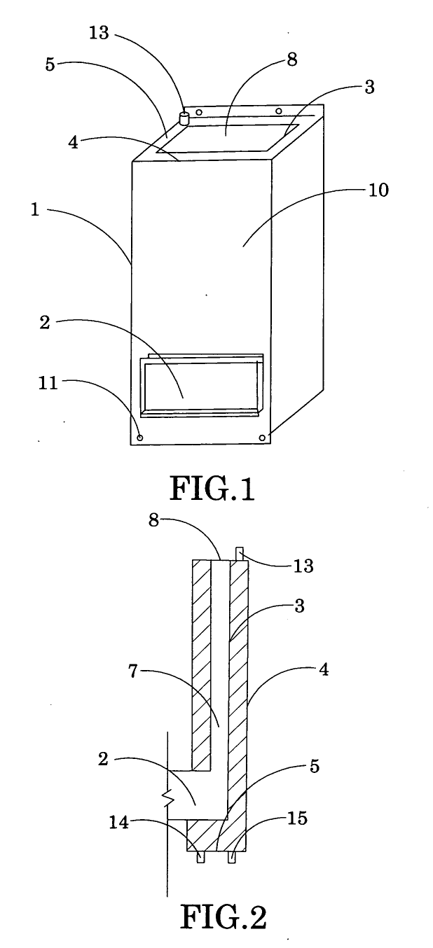

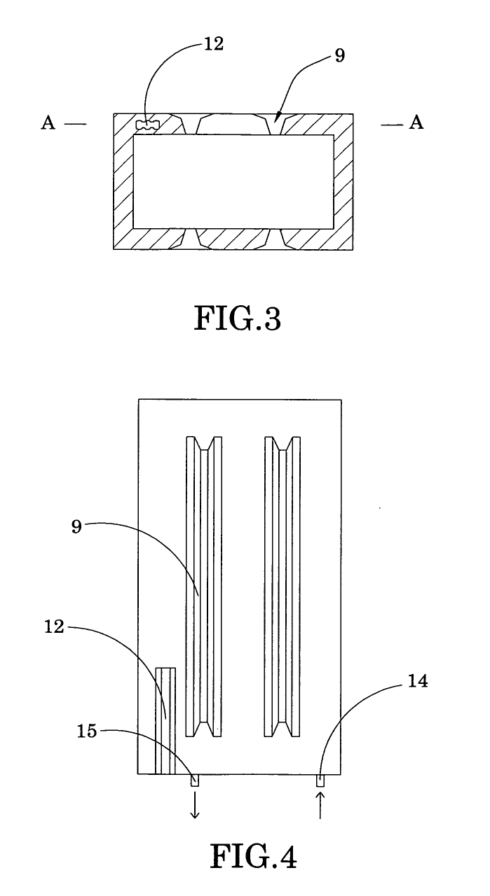

Referring to FIGS. 1 to 4 of the drawing, a fuel saving cooker and water heater arrangement according to a preferred embodiment of the present invention is illustrated, which comprises a water tank 1 communicatively linking to a food cooking apparatus, such as an oil fryer. The water tank 1 has a heat inlet 2 provided at a bottom portion to communicating with the food cooking apparatus. The water tank 1 further comprises an inner tank body 3 and an outer tank body to form a sealed water chamber 5 between the inner and outer tank bodies 3, 4. Each of the inner and outer tank bodies 3, 4 has a sealed base panel 6 to define the heat inlet 2 above the base panel 6, wherein the heat inlet 2 communicates with the heat chamber 5.

The outer tank body 4 further comprises a plurality of indented reinforcing ribs 9 built-in therewithin to enhance strength of the tank body and to extend the life span of the tank body. Furthermore, the reinforcing ribs 9, made of thermal conductive material, can evenly distribute the excessive heat within the heat chamber 5.

For better installation of the water heater, a screw hole 11 is provided at the side wall 10 of the outer tank body 4 thereof to engage with the steam outlet at the oil cooker.

For security and safety purpose, a safety valve 13 is provided for the sealed water chamber 5.

In order to discharge steam efficiently, the ventilating device, such as a fan, is mounted at the top side of the water tank 1 at the heat outlet 8 thereof.

The water tank 1 comprises a water inlet 14 and a water outlet 15 at the bottom portion of the water tank 1 to communicate with the water chamber 5.

The water tank 1 further comprises a supplemental heater 12, such as an electric heater, provided at the water chamber 5 for generating an additional heat therewithin, wherein the supplemental heater 12 is located adjacent to the water outlet 15 for ensuring the water in the water chamber 5 being heated up at a predetermined temperature before the water exits at the water outlet 15.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. A fuel saving cooker and water heater arrangement, comprising a water heater operatively connecting to a food cooking apparatus, wherein said water heater has a bottom heat inlet communicating with said food cooking apparatus, wherein said water tank comprises an inner tank body and an outer tank body to define a water chamber between said inner and outer tank bodies, wherein said water tank further has a heat chamber provided within said inner tank bodies to communicate with said heat inlet and to thermally communicate with said water chamber, and an upper heat outlet communicating with said heat chamber, wherein an excessive heat from said food cooking apparatus is guided to pass to said heat chamber through said heat inlet to heat up water within said water chamber.

2. The fuel saving cooker and water heater arrangement, as recited in claim 1, wherein said outer tank body further comprises a plurality of indent reinforcing ribs built-in therewithin to enhance a strength of said water tank.

3. The fuel saving cooker and water heater arrangement, as in claim 1, wherein said water tank further comprises a supplemental heater.

4. The fuel saving cooker and water heater arrangement, as recited in claim 3, wherein a screw hole is provided at a side wall of said outer tank body thereof to engage said heat inlet with a steam outlet of said food cooking apparatus.

5. The fuel saving cooker and water heater arrangement, as recited in claim 4, further comprising a safety valve provided at said water chamber.

6. The fuel saving cooker and water heater arrangement, as recited in claim 5, further comprising a ventilating device provided at a top side of said water tank at said heat outlet thereof for discharging steam from said food cooking apparatus.

7. The fuel saving cooker and water heater arrangement, as recited in claim 6, wherein said water tank further comprises a water inlet and outlet provided thereat to communicate with said water chamber.

8. A fuel saving cooker and water heater arrangement, comprising a water heater operatively connecting to a food cooking apparatus, wherein said water heater has a bottom heat inlet communicating with said food cooking apparatus, wherein said water tank comprises an inner tank body and an outer tank body to define a water chamber between said inner and outer tank bodies, wherein said water tank further has a heat chamber provided within said inner tank bodies to communicate with said heat inlet and to thermally communicate with said water chamber, and an upper heat outlet communicating with said heat chamber, wherein an excessive heat from said food cooking apparatus is guided to pass to said heat chamber through said heat inlet to heat up water within said water chamber;
wherein said outer tank body further comprises a plurality of indent reinforcing ribs built-in therewithin to enhance a strength of said water tank; and
said water tank further comprises a supplemental heater.

9. The fuel saving cooker and water heater arrangement, as recited in claim 8, wherein a screw hole is provided at a side wall of said outer tank body thereof to engage said heat inlet with a steam outlet of said food cooking apparatus.

10. The fuel saving cooker and water heater arrangement, as recited in claim 9, further comprising a safety valve provided at said water chamber.

11. The fuel saving cooker and water heater arrangement, as recited in claim 10, further comprising a ventilating device provided at a top side of said water tank at said heat outlet thereof for discharging steam from said food cooking apparatus.

12. The fuel saving cooker and water heater arrangement, as recited in claim 6, wherein said water tank further comprises a water inlet and outlet provided thereat to communicate with said water chamber.
